(19) United States
(12) Patent Application Publication
(10) Pub. No.: US 2022/0250532 A1
(43) Pub. Date: Aug. 11, 2022

(54) ARRANGEMENT AND METHOD FOR SECURING A LOAD IN A VEHICLE

(71) Applicant: Ningbo Geely Automobile Research & Development Co., Ltd., Ningbo (CN)

(72) Inventors: Magnus NILSSON, Floda (SE); Jonathan JOHANSSON, Göteborg (SE)

(21) Appl. No.: 17/732,318

(22) Filed: Apr. 28, 2022

Related U.S. Application Data
(63) Continuation of application No. PCT/CN2020/125400, filed on Oct. 30, 2020.

(30) Foreign Application Priority Data
Nov. 22, 2019 (EP) 19210884.3

(51) Int. Cl. B60P 7/08; B60R 7/00

(52) U.S. Cl. CPC B60P 7/0838; B60P 7/0861; B60R 7/005

(57) ABSTRACT

A vehicle load-securing arrangement includes a first load-securing device arranged to be attachable to a load-securing member and a first tensioning device arranged to be attached to the first load-securing device by a first tensioning member. The first load-securing device is arranged to be connected to a vehicle body part or a vehicle chassis part. The first load-securing device is arranged to be movable in an axial direction of the first load-securing device in a first opening in a loading surface of a vehicle by operating the first tensioning device.

### RELATED APPLICATION DATA

This application is a continuation of International Patent Application No. PCT/CN2020/125400, filed Oct. 30, 2020, which claims the benefit of European Patent Application No. 19210884.3, filed Nov. 22, 2019, the disclosures of which are incorporated herein by reference in their entireties.

### TECHNICAL FIELD

The disclosure relates to a vehicle load-securing arrangement comprising a first load-securing device arranged to be attachable to a load-securing member and a first tensioning device arranged to be attached to the first load-securing device by a first tensioning member. The first load-securing device is arranged to be connected to a vehicle body part or a vehicle chassis part. The disclosure also relates to a method for securing a load in a vehicle.

### BACKGROUND

Today's vehicles comprise various means for securing a load in the luggage or storage compartment. One such means are load rings placed around the luggage compartment through which a luggage strap or similar can be fed and placed around a load to secure it in place. It can be difficult to tighten a strap placed around a load properly due to that the amount of space near the load ring can be limited. This may lead to that a load will not be secured as tightly as desired and can result in damage to the load and/or to the luggage compartment.

WO 2018/072981 A1 discloses a device for securing loads on a transport surface of a vehicle. The device comprises a flexible securing means fixed to two or more anchor points that can be wrapped around the load. The device comprises a tensioning device and a tension-measuring element for measuring the tension of the securing means.

The device of WO 2018/072981 A1 requires a tensioning device that is attached between the load rings of the luggage compartment and the flexible securing means. This can be difficult to attach properly if there is little space between the load and the load rings.

There is thus a need for improvement within the field of securing loads in the luggage or storage compartment of a vehicle.

### SUMMARY

An objective of the disclosure is to provide a load-securing arrangement and a method for securing a load in a vehicle.

The disclosure relates to a vehicle load-securing arrangement comprising a first load-securing device arranged to be attachable to a load-securing member and a first tensioning device arranged to be attached to the first load-securing device by a first tensioning member. The first load-securing device is arranged to be connected to a vehicle body part or a vehicle chassis part. The first load-securing device is arranged to be movable in an axial direction of the first load-securing device in a first opening in a loading surface of a vehicle by operating the first tensioning device.

One advantage with the arrangement according to the disclosure is that the first load-securing device of the arrangement, by means of the first tensioning device, manually or automatically can be used to secure a load inside the vehicle. As some loads can be difficult to secure properly due to their size or shape or due to physical restraints of the person loading the vehicle, the arrangement can assist in tightening a load-securing member that is used to secure a load.

A first force sensing means may be arranged on the first load-securing device or the first tensioning device and arranged to sense a tensioning force exerted on the load-securing member by the first load-securing device. The first tensioning device may increase the tension until a predetermined tensioning force exerted on the load-securing member by the first load-securing device is detected by the first force sensing means.

Some loads, such as cardboard boxes, soft plastic boxes or bags or similar may be flexible and can collapse if put under too much pressure or stress. In order to prevent damage to such loads, a first force sensing means will shut off the tensioning of the tensioning means if the tensioning force exerted on the load-securing member by the first load-securing device exceeds a predetermined tensioning force.

The first load-securing device may be arranged to be connected to the vehicle body part or the vehicle chassis part with a resilient member.

The resilient member limits the travel of the first load-securing device in the axial direction as the first tensioning device is operated and thereby pulls on the first load-securing device to tighten the load-securing member. The resilient member may also assist in releasing the tension exerted by the load-securing member on the load when the first tensioning device is not operated as the first load-securing device is pushed in the opposite direction by the resilient member.

The first load-securing device may be arranged to be positioned underneath the loading surface in an inactive state and is arranged to protrude out of the loading surface in an active state. The first load-securing device may be put in the active state upon a user input or by the first load-securing device being exerted to an axial force.

If the first load-securing device is arranged to be positioned underneath the loading surface in an inactive state, i.e. when not in use, more of the loading space can be utilized as there will be no protrusions preventing some parts of the loading space to be used.

The arrangement may further comprise a second load-securing device arranged to be attachable to the load-securing member and to the first tensioning device by a second tensioning member. The second load-securing device is arranged to be connected to a vehicle body part or a vehicle chassis part and the second load-securing device is arranged to be movable in an axial direction of the second load-securing device in a second opening in a loading surface of a vehicle by operating the first tensioning device.

In a first example embodiment, the arrangement comprises a second load-securing device that works in tandem with the first load-securing device. In order to be able to provide tension from more than one load-securing device, and thereby reduce the amount of tension needing to be provided by a single load-securing device, a second load-securing device can be arranged to be attached to the first tensioning device. This allows the first tensioning device to provide tension to the load via the load-securing member by having two load-securing devices move in their respective axial directions.

The arrangement may further comprise a second load-securing device arranged to be attachable to the load-securing member and to a second tensioning device by a second tensioning member, wherein the second load-securing device is arranged to be connected to a vehicle body part or a vehicle chassis part, the second load-securing device is arranged to be movable in an axial direction of the second load-securing device in a second opening in a loading surface of a vehicle by operating the second tensioning device.

In a second example embodiment, the arrangement comprises a second load-securing device that works in tandem with the first load-securing device. In the second example embodiment, the second load-securing device can be arranged to be attached to a second tensioning device. This allows the first and second tensioning devices to provide tension to the load via the load-securing member by having two load-securing devices move in their respective axial directions. In this way, different tension can be applied by the first and second load-securing devices on the load-securing member by having the first and second tensioning devices apply different tension on the first and second load-securing devices.

A second force sensing means may be arranged on the second load-securing device or the second tensioning device, where the second force sensing means is arranged to sense a tensioning force exerted on the load-securing member by the second load-securing device. The second tensioning device may increase the tension until a predetermined tensioning force exerted on the load-securing member by the second load-securing device is detected by the second force sensing means.

When using two load-securing devices, each being arranged to be connected to a separate tensioning device, it is as mentioned above, possible to apply different tension by the first and second load-securing devices. By having a second force sensing means arranged on the second load-securing device or the second tensioning device, it is possible to shut off the tensioning of the second tensioning device if a predetermined tensioning force is detected by the second force sensing means while still increasing the tensioning of the first tensioning device. This may be useful for irregularly shaped loads or loads with different materials in different part of the load.

Both the first and second force sensing means can have a safety function built in that stops the tensioning device if any force sensing means detects a sudden decrease in tensioning force after a steady increase. This would indicate that the load has compacted or changed shape, which can happen if for instance a cardboard box or a soft plastic container is the load. The safety function leads to that the tensioning device does not damage the load further. An alarm can also be transmitted, for instance aurally, visually, haptically or by message to a user's phone or the vehicle's human-machine interface.

The second load-securing device may be arranged to be connected to the vehicle body part or a vehicle chassis part with a resilient member.

The resilient member of the second load-securing device limits the travel of the second load-securing device in the axial direction as the first or second tensioning device is operated and thereby pulls on the second load-securing device to tighten the load-securing member. The resilient member also assists in releasing the tension exerted by the load-securing member on the load when the second tensioning device is not operated as the second load-securing device is pushed in the opposite direction by the resilient member.

The first and/or second tensioning device may be one of:
Automatic ratchet strap,
Belt retractor,
Manual pulley system.

The first and second tensioning device can be automatic or manual. The first, and if applicable, second force sensing means can be used with any one of the mentioned examples of tensioning devices.

The first tensioning device and/or the second tensioning device may be arranged to apply tension to the first load-securing device and/or the second load-securing device upon receiving a tensioning trigger, wherein the tensioning trigger is one of or a combination of:
The vehicle starting,
Identification of driver and/or passenger seated in the vehicle,
Activation by driver or passenger,
Closing of the vehicle's storage compartment.

When the load is ready to be secured and the load-securing member is in place over and/or around the load, the first and/or second tensioning devices may start to apply tension to the first load-securing device and/or the second load-securing device upon receiving a tensioning trigger. As a first non-limiting example, the first tensioning device and/or the second tensioning device can start the tensioning upon identification of a driver and/or passenger seated in the vehicle and the vehicle starting. As a further non-limiting example, a switch in for instance the vehicle's centre console, in a vehicle door panel or in the luggage compartment can be activated by the driver or a passenger as a tensioning trigger. This can be done with the motor running or not. Activation by the driver or passenger can be made as a one-touch function where one press automatically applies tensions to the first and/or second load-securing devices until a predetermined tensioning force is measured. Activation by the driver or passenger can also be made as a continuous command where the switch can be pressed until a desired tensioning has been achieved or until a predetermined tensioning force is measured. Further combinations and other examples of tensioning triggers are of course conceivable.

The first and/or second tensioning device may be arranged to release tension of the first and/or second load-securing device upon receiving a release trigger.

When the load is ready to be unloaded from the vehicle, the tension of the load-securing member must be released in order for the load-securing member to be removed from the load. The tension of the first and/or second load-securing device must be released in order to do this. In order to control the release of tension, the arrangement may receive a release trigger. The release trigger can for instance be one of or a combination of the vehicle's motor being turned off, detection of driver and/or passenger exiting the vehicle, manual release activation by driver or passenger or closing of the vehicle's storage compartment. As a first non-limiting example, the motor being turned off and the driver and all passengers having exited the vehicle can be a release trigger. As a further non-limiting example, a switch in for instance the vehicle's centre console, in a vehicle door panel or in the luggage compartment can be activated by the driver or a passenger as a release trigger. This can be done with the motor running or not. Further combinations and other examples of release triggers are of course conceivable.

The disclosure also relates to a vehicle comprising a vehicle load-securing arrangement according to the above description.

The disclosure also relates to a method for securing a load in a vehicle, wherein the method comprises:
attaching a first load-securing device to a vehicle body arranged to be movable in an axial direction of the first load-securing device in an opening in a loading surface of a vehicle,
arranging a first tensioning device to be attached to the first load-securing device by a first tensioning member,
operating the first tensioning device to increase or decrease tension on the load-securing member.

The method may further comprise:
attaching a second load-securing device to the vehicle body arranged to be movable in an axial direction of the second load-securing device in a second opening in the loading surface of a vehicle,
arranging a first tensioning device or a second tensioning device to be attached to the second load-securing device by a second tensioning member,
operating the first tensioning device and/or the second tensioning device to increase or decrease tension on the load-securing member.

The method may further comprise:
operating the first tensioning device upon receipt of a tensioning or a release trigger.

The method provides the same advantages as described in conjunction with the arrangement.

### BRIEF DESCRIPTION OF THE DRAWINGS

FIG. 1A schematically shows a vehicle load-securing arrangement according to a first embodiment of the disclosure in an inactive state,

FIG. 1B schematically shows a vehicle load-securing arrangement according to the first embodiment of the disclosure in an active state without tension applied to the load,

FIG. 1C schematically shows a vehicle load-securing arrangement according to the first embodiment of the disclosure in an active state with tension applied to the load,

FIG. 2 schematically shows a vehicle load-securing arrangement according to a second embodiment of the disclosure in an active state,

FIG. 3 schematically shows a vehicle load-securing arrangement according to a third embodiment of the disclosure in an active state,

FIGS. 4A and 4B schematically show a vehicle load-securing arrangement according to a fourth embodiment of the disclosure in an active state,

FIG. 5 schematically shows a vehicle comprising a vehicle load-securing arrangement according to the disclosure.

### DETAILED DESCRIPTION

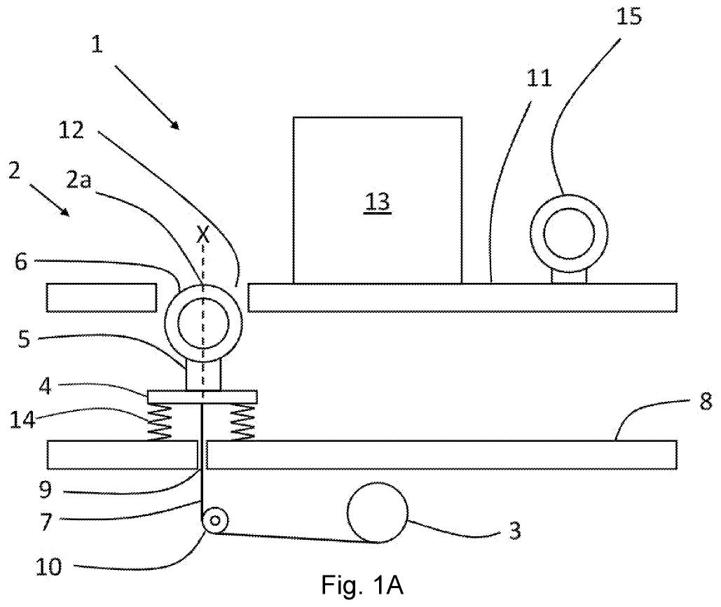

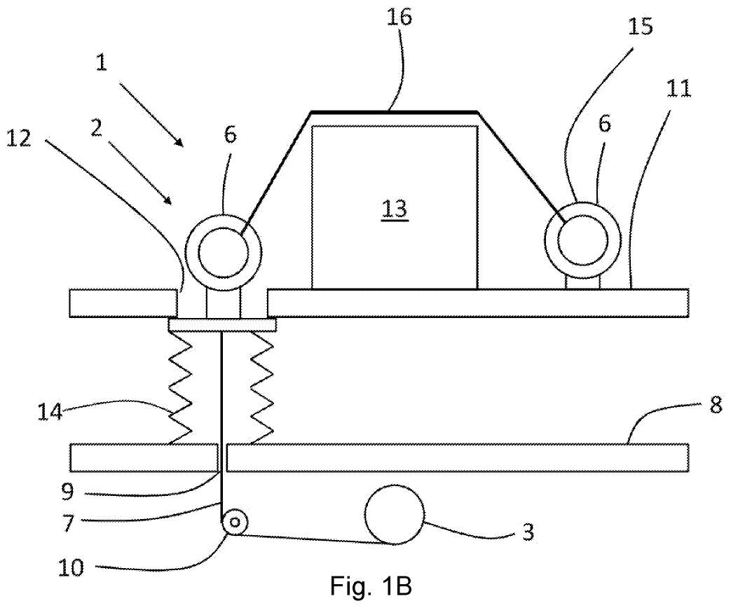

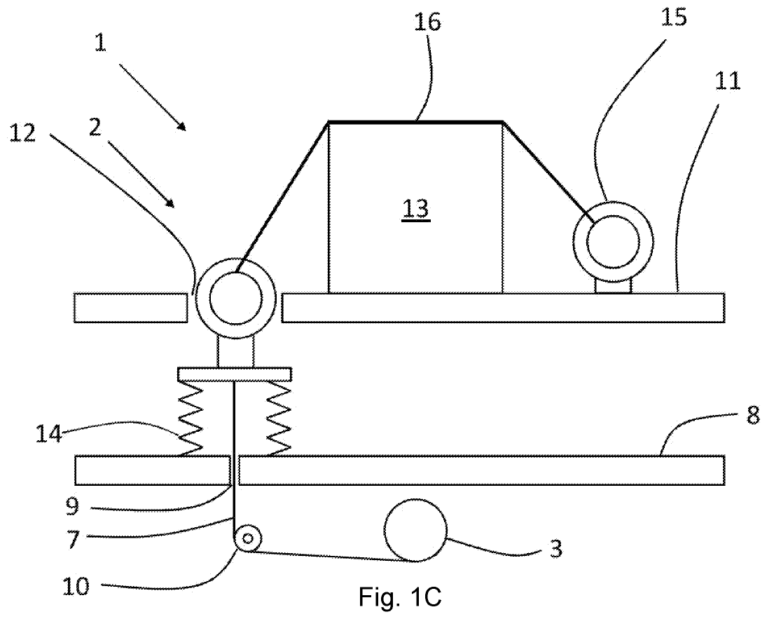

FIG. 1A schematically shows a vehicle load-securing arrangement 1 according to a first embodiment of the disclosure in an inactive state. The vehicle load-securing arrangement 1 comprises a first load-securing device 2 arranged to be attachable to a load-securing member (not shown) and a first tensioning device 3. The first load-securing device 2 comprises a base 4 attached to a stem 5 which in turn is attached to a load-securing loop 6 or similar. In the load-securing loop 6, an end of the load-securing member can be attached. The load-securing loop 6 can be firmly attached to the stem 5 or be attached in such a way that it can rotate and/or change angle relative an axial direction.

The first tensioning device 3 is arranged to be attached to the first load-securing device 2 by a first tensioning member 7. The first load-securing device 2 is arranged to be connected to a vehicle body part 8 or a vehicle chassis part 8, in FIG. 1A illustrated by a level surface. The vehicle body part 8 or a vehicle chassis part 8 can also have other shapes depending on where the connection between the vehicle body part 8 or vehicle chassis part 8 and the first load-securing device 2 is most efficient. The vehicle body part 8 or a vehicle chassis part 8 may comprise a first tensioning member opening 9 through which the first tensioning member 7 runs to the first tensioning device 3 via a first pulley 10. The first pulley 10 is optional and can be used to place the first tensioning device 3 in a suitable location in the vehicle. Also more than one pulley 10 between the first tensioning device 3 and the first load-securing device 2 is conceivable within the scope of the disclosure.

In the inactive state, the first load-securing device 2 is positioned such that an uppermost part 2a of the first load-securing device 2 does not extend above a loading surface 11 of the vehicle. The first load-securing device 2 is arranged to be movable in an axial direction X of the first load-securing device 2 in a first opening 12 in the loading surface 11 of the vehicle by operating the first tensioning device 3. The axial direction X is the direction running through the length of the first load-securing device 2, i.e. the direction extending from the base 4 and through the stem 5. In FIG. 1A, this direction is upwards. On the loading surface 11, a load 13 is positioned and waiting to be secured.

In FIG. 1A, the first load-securing device 2 is arranged to be connected to the vehicle body part 8 or the vehicle chassis part 8 with a resilient member 14. The resilient member 14 may for instance be a coil spring, a volute spring or a disk spring. The resilient member 14 can be biased for mainly compression, mainly extension or something in between such that when the first load-securing device 2 is in the inactive state, the resilient member 14 may experience neither compression nor extension.

In the example of FIG. 1A, the first load-securing device 2 is kept in the inactive state by that the first tensioning device 3 has pulled down the first load-securing device 2. As an alternative, the stem 5 or the base 4 of the first load-securing device 2 can be movably attached to the vehicle body part 8 or the vehicle chassis part 8, such that the first load-securing device 2 can be moved in the axial direction by an electric motor or by manual force.

In the first embodiment of the vehicle load-securing arrangement 1, a second load-securing device 15 arranged to be attachable to the load-securing member is fixedly attached to the loading surface 11.

FIG. 1B schematically shows the vehicle load-securing arrangement 1 according to the first embodiment of the disclosure in an active state without tension applied to the load 13 by a load-securing member 16. The vehicle load-securing arrangement 1 may be put in the active state by for instance detecting placement of the load-securing member 16 in the load-securing loop 6 of the first load-securing device 2, by pulling and releasing the first load-securing device 2, i.e. exerting an axial force on the first load-securing device 2, or by activation by a user interface, either inside a luggage compartment of the vehicle or in a human-machine interface inside the vehicle.

In the example of FIG. 1B, the first load-securing device 2 has been pushed upwards in the axial direction of the first load-securing device 2 by the resilient member 14 such that it extends through and out of the loading surface 11. In this way, the load-securing loop 6 is easily accessible. In FIG. 1B, the load-securing member 16 has been attached to the load-securing loops 6 of the first load-securing device 2 and the second load-securing device 15 respectively. No tension has yet been applied and there is some slack of the load-securing member 16.

FIG. 1C schematically shows a vehicle load-securing arrangement 1 according to the first embodiment of the disclosure in an active state with tension applied to the load 13. When the first tensioning device 3 has been triggered, for instance by one or a combination of the vehicle starting, identification of driver and/or passenger seated in the vehicle, activation by driver or passenger and closing of the vehicle's storage compartment, the first tensioning device 3 applies tension to the first tensioning member 7 resulting in that the first load-securing device 2 is pulled downwards in the axial direction, thereby tightening the load-securing member 16 around the load 13. In FIGS. 1B and 1C, the load-securing member 16 is placed on top of the load 13. This is for illustrative purposes only and the load-securing member 16 can be placed on various parts of the load 13 depending on what the load 13 looks like.

A first force sensing means (not shown) may be arranged on the first load-securing device 2 or the first tensioning device 3 and arranged to sense a tensioning force exerted on the load-securing member 16 by the first load-securing device 2. The first tensioning device 3 is arranged to increase the tensioning force on the first tensioning member 7, and thereby on the load-securing member 16 by the first load-securing device 2 until a predetermined tensioning force exerted on the load-securing member 16 by the first load-securing device 2 is detected by the first force sensing means. The first force sensing means can be any suitable force sensing means known in the art.

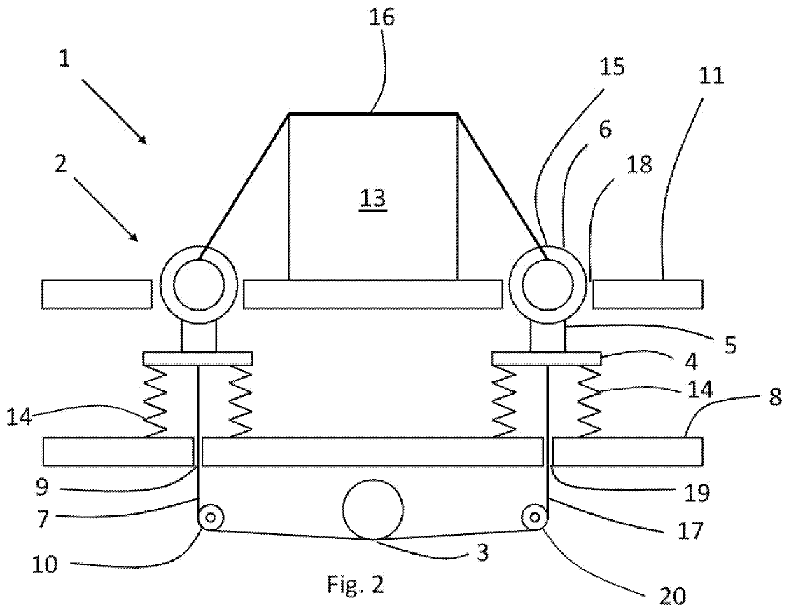

FIG. 2 schematically shows a vehicle load-securing arrangement 1 according to a second embodiment of the disclosure in an active state. The second embodiment differs from the first embodiment in that the second load-securing device 15 also is arranged to be attachable to the load-securing member 16 and to the first tensioning device 3 by a second tensioning member 17. The second load-securing device 15 comprises similar parts 4, 5, 6 as the first load-securing device 2 and is arranged to be connected to a vehicle body part 8 or a vehicle chassis part 8, with or without a resilient member 14 in the same way as described above for the first load-securing device 2. The second load-securing device 15 is arranged to be movable in an axial direction of the second load-securing device 15 in a second opening 18 in the loading surface 11 of the vehicle by operating the first tensioning device 3.

The vehicle body part 8 or a vehicle chassis part 8 comprises in this example a second tensioning member opening 19 through which the first tensioning member 7 runs to the first tensioning device 3 via a second pulley 20. The second pulley 20 is optional and can together with the first pulley 10 be used to place the first tensioning device 3 in a suitable location in the vehicle. Also more than one pulley 20 between the first tensioning device 3 and the second load-securing device 15 is conceivable within the scope of the disclosure.

In this example embodiment, both the first and the second load-securing devices 2, 15 move at the same time when the first tensioning device 3 is triggered. This provides an even distribution of the force exerted by the load-securing member 16 on the load 13. It is possible to arrange the attachment of the first load-securing device 2 and the second load-securing device 15 to the vehicle body part 8 or vehicle chassis part 8 by resilient members 14 with different spring constants if different forces exerted by the load-securing member 16 is desired on different parts of the load. Using different sized pulleys 10, 20 or different number of pulleys 10, 20 may also lead to different forces acting on the load 13.

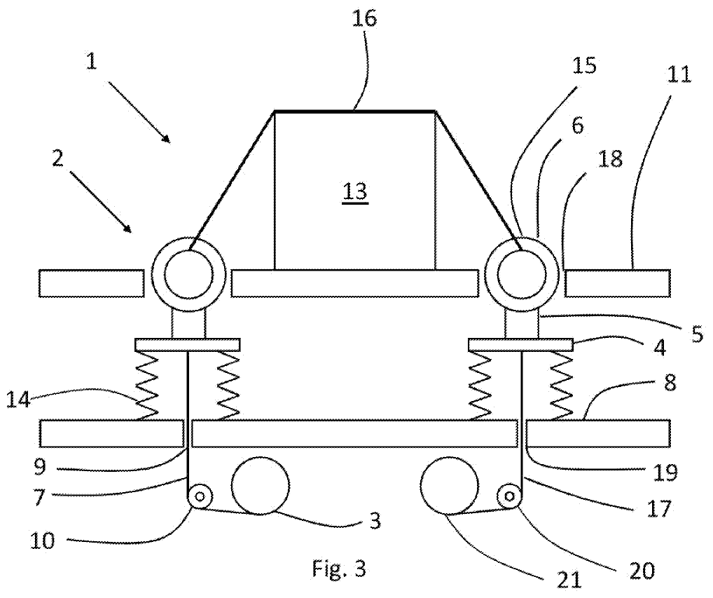

FIG. 3 schematically shows a vehicle load-securing arrangement 1 according to a third embodiment of the disclosure in an active state. The difference between the second embodiment and the third embodiment is that in the third embodiment, the first load-securing device 2 is arranged to be attached to the first tensioning device 3 by the first tensioning member 7 and the second load-securing device 15 is arranged to be attached to a second tensioning device 21 by the second tensioning member 17. In this way, the first and second load-securing devices 2, 15 can be operated separately or together, depending on the desired setting. The first and second tensioning devices 3, 21 can be arranged to exert different tension on the first and second tensioning members 7, 17 respectively to control the force exerted by the load-securing member 16 on the load 13.

When using a second load-securing device 15, a second force sensing means (not shown) may be arranged on the second load-securing device 15 or the second tensioning device 21 (if present). The second force sensing means is arranged to sense a tensioning force exerted on the load-securing member 16 by the second load-securing device 15 in the same way as described above for the first force sensing means. The second tensioning device 21 increases the tension until a predetermined tensioning force exerted on the load-securing member 16 by the second load-securing device 15 is detected by the second force sensing means. The first and second force sensing means can be set to detect the same predetermined tensioning force by each of the force sensing means or be set to detect different predetermined tensioning forces. The one or different predetermined tensioning forces can be set automatically or manually depending on the load 13 to be secured. Automatic setting can for instance be made by entering the material of the load 13 to be secured, pre-set tensioning forces can be drawn from a look-up table.

In the figures, the first and/or second tensioning devices 3, 21 is one of an automatic ratchet strap, a belt retractor (i.e. a mechanism similar to the ones used to automatically retract seat belts) or a manual pulley system. In the manual pulley system, the first and/or second tensioning devices are operated by hand and can comprise a string, rope, strap or similar wound to a drum that can be releasably locked in various positions corresponding to various amount of a tensioning force.

Alternatively, the first and second tensioning devices 3, 21 could comprise a Bowden cable system or one or more hydraulic cylinders where the piston is attached to the first and/or second tensioning members 7, 17. Combinations of the mentioned tensioning devices are also possible.

The first and/or second tensioning devices 3, 21 are arranged to release the tension of the first and/or second load-securing devices 2, 15 on the load-securing member 16 upon receiving a release trigger. This causes the load securing device or devices 2, 15 to return to the active state of FIG. 1B, where there is no tension applied to the load-securing member 16. The load 13 can thereby be removed from the loading surface 11.

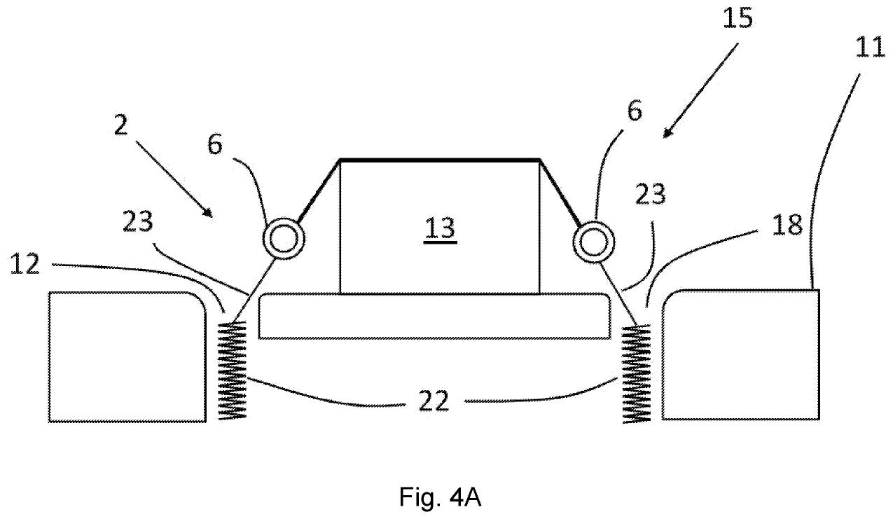

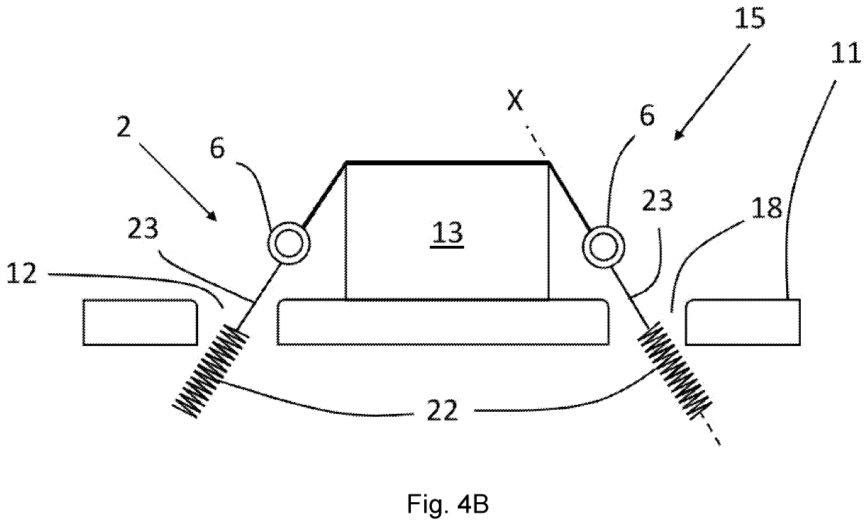

FIGS. 4A and 4B schematically show a vehicle load-securing arrangement 1 according to a fourth embodiment of the disclosure in an active state. In FIGS. 4A and 4B, the first and second load-securing devices 2, 15 comprise threaded rods 22 to which the load-securing loop 6 is attached by means of a flexible attaching member 23. The threaded rods 22 can be moved upwards and downwards along their respective axial directions by means of a motor driving a worm gear, screw actuator or similar to cause the threaded rod 22 to move. In FIG. 4A, the first and second load-securing devices 2, 15 are arranged to move essentially perpendicular to a horizontal plane of the loading surface 11.

In FIG. 4B, the first and second load-securing devices 2, 15 are arranged at an angle relative the loading surface 11. In this example, the axial direction X of the respective load-securing devices 2, 15 are also at an angle relative the loading surface 11.

Also, as seen from the figures, the edges of the first and second openings 12, 18 are rounded such that the flexible attaching member 23 will not wear if the flexible attaching member 23 lies against the edges when the load-securing devices 2, 15 tightens the load-securing member 16 against the load 13.

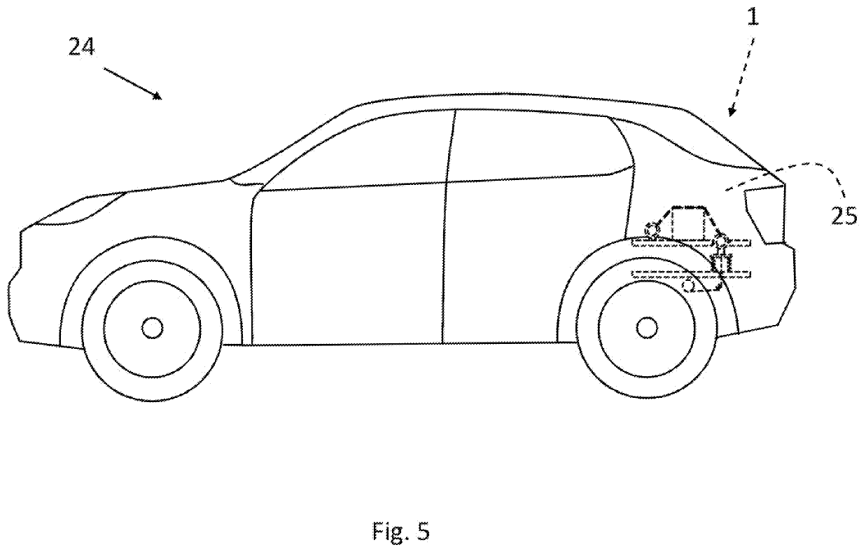

FIG. 5 schematically shows a vehicle 24 comprising a vehicle load-securing arrangement 1 according to the disclosure. As can be seen, the vehicle load-securing arrangement 1 is placed in the luggage compartment 25 of the vehicle 22. For a larger vehicle, such as a van, the vehicle load-securing arrangement 1 is placed in a storage compartment 25. The details are otherwise the same. The arrangement according to the disclosure can be used in all types of vehicles, such as cars, vans, airplanes, ships, trains etc.

Although the disclosure has been illustrated and described in detail in the drawings and foregoing description, such illustrations and descriptions are to be considered illustrative or exemplary and the disclosure is not limited to the disclosed example embodiments. For instance, the load-securing devices 2, 15 of FIGS. 1A-3 can also be arranged at angle relative the horizontal plane of the loading surface 11, similar to the example embodiment of FIG. 4B. Also, the load-securing devices 2, 15 could comprise hydraulic or pneumatic cylinders with the cylinder tube forming the base 4 and the piston forming the stem 5 to which a load-securing loop 6 is attached. The hydraulic cylinder is for instance powered by a hydraulic pump, while the pneumatic cylinder may be powered by a pneumatic pump.

What is claimed is:

1. A vehicle load-securing arrangement comprising a first load-securing device arranged to be attachable to a load-securing member and a first tensioning device arranged to be attached to the first load-securing device by a first tensioning member, wherein the first load-securing device is arranged to be connected to a vehicle body part or a vehicle chassis part, wherein the first load-securing device is arranged to be movable in an axial direction of the first load-securing device in a first opening in a loading surface of a vehicle by operating the first tensioning device.

2. The vehicle load-securing arrangement according to claim 1, wherein a first force sensing means is arranged on the first load-securing device or the first tensioning device and arranged to sense a tensioning force exerted on the load-securing member by the first load-securing device, wherein the first tensioning device increases the tension until a predetermined tensioning force exerted on the load-securing member by the first load-securing device is detected by the first force sensing means.

3. The vehicle load-securing arrangement according to claim 1, wherein the first load-securing device is arranged to be connected to the vehicle body part or the vehicle chassis part with a resilient member.

4. The vehicle load-securing arrangement according to claim 1, wherein the first load-securing device is arranged to be positioned underneath the loading surface in an inactive state and is arranged to protrude out of the loading surface in an active state and wherein the first load-securing device is put in the active state upon a user input or by the first load-securing device being exerted to an axial force.

5. The vehicle load-securing arrangement according to claim 1, wherein the arrangement further comprises a second load-securing device arranged to be attachable to the load-securing member and to the first tensioning device by a second tensioning member, wherein the second load-securing device is arranged to be connected to a vehicle body part or a vehicle chassis part, the second load-securing device is arranged to be movable in an axial direction of the second load-securing device in a second opening in the loading surface of the vehicle by operating the first tensioning device.

6. The vehicle load-securing arrangement according to claim 1, wherein the arrangement further comprises a second load-securing device arranged to be attachable to the load-securing member and to a second tensioning device by a second tensioning member, wherein the second load-securing device is arranged to be connected to a vehicle body part or a vehicle chassis part, the second load-securing device is arranged to be movable in an axial direction of the second load-securing device in a second opening in the loading surface of the vehicle by operating the second tensioning device.

7. The vehicle load-securing arrangement according to claim 6, wherein a second force sensing means is arranged on the second load-securing device or the second tensioning device, the second force sensing means being arranged to sense a tensioning force exerted on the load-securing member by the second load-securing device, wherein the second tensioning device increases the tension until a predetermined tensioning force exerted on the load-securing member by the second load-securing device is detected by the second force sensing means.

8. The vehicle load-securing arrangement according to claim 5, wherein the second load-securing device is arranged to be connected to the vehicle body part or a vehicle chassis part with a resilient member.

9. The vehicle load-securing arrangement according to claim 1, wherein the first and/or second tensioning device is one of:
automatic ratchet strap,
belt retractor,
manual pulley system,
threaded rod connected to a worm gear or screw actuator,
hydraulic cylinder and piston.

10. The vehicle load-securing arrangement according to claim 1, wherein the first tensioning device and/or the second tensioning device is arranged to apply tension to the first load-securing device and/or the second load-securing device upon receiving a tensioning trigger, wherein the tensioning trigger is one of:
the vehicle starting,
identification of driver and/or passenger seated in the vehicle,
activation by driver or passenger,
closing of the vehicle's luggage/storage compartment.

11. The vehicle load-securing arrangement according to claim 1, wherein the first and/or second tensioning device are arranged to release tension of the first and/or second load-securing device upon receiving a release trigger.

12. The vehicle comprising a vehicle load-securing arrangement according to claim 1.

13. A method for securing a load in a vehicle, wherein the method comprises:
attaching a first load-securing device to a vehicle body part or a vehicle chassis part arranged to be movable in an axial direction of the first load-securing device in a first opening in a loading surface of the vehicle,
arranging a first tensioning device to be attached to the first load-securing device by a first tensioning member,
operating the first tensioning device to increase or decrease tension on a load-securing member.

14. The method according to claim 13, wherein the method comprises:
attaching a second load-securing device to the vehicle body part or vehicle chassis part arranged to be movable in an axial direction of the second load-securing device in a second opening in the loading surface of the vehicle,
arranging a first tensioning device or a second tensioning device to be attached to the second load-securing device by a second tensioning member,
operating the first tensioning device and/or the second tensioning device to increase or decrease tension on the load-securing member.

15. The method according to claim 13, wherein the method comprises:
operating the first tensioning device upon receipt of a tensioning or a release trigger.
